(19) United States
(12) Patent Application Publication
(10) Pub. No.: US 2005/0044369 A1
(43) Pub. Date: Feb. 24, 2005

(54) Electronic document management system

(76) Inventor: Lakshminarayanan Anantharaman, Singapore (SG)

Correspondence Address: Stephen M De Klerk;Blakely Sokoloff Taylor & Zafman, Seventh Floor, 12400 Wilshire Boulevard, Los Angeles, CA, 90025, US

(21) Appl. No.: 10/493,079

(22) PCT Filed: Oct. 15, 2001
(86) PCT No.: PCT/SG01/00208

(51) Int. Cl. H04L 9/00

(52) U.S. Cl. 713/176

(57) ABSTRACT

An apparatus, method and computer program for the management of digital information bearing digital signatures is disclosed. The invention includes an apparatus for the management of digital information in a database. This apparatus further includes the means for importing the digital information; means for processing the digital information, wherein the digital information may include at least one digital document, at least one digital signature, at least one public key certificate, at least one archival policy; means for obtaining data from an external server and means for exporting output information from the apparatus, whereby a user when importing the digital information to the apparatus, causes the digital information to be processed thereby generating the output information that is stored in the database.

### FIELD OF INVENTION

This invention relates generally to the management of digital documents, and in particular the management and archival of digitally signed documents.

### BACKGROUND OF THE INVENTION

Brief Introduction to Cryptography

A cursory overview of the cryptographic techniques that make up a Public-Key infrastructure (PKI) is outlined. The focus here is on the general properties of the cryptographic techniques, as an in-depth discussion of each method's various scheme is beyond the scope of this document.

Secret-Key Cryptography

Secret-key cryptography is the classical form of cryptography. With a secret-key cryptosystem, two persons know the key used for encryption and decryption. This requires prior communication between both persons over a secure channel, so that they may agree on a key. An example secret-key system is the Data Encryption Standard (DES).

There exist systems for communicating securely over public networks using only secret-key cryptography, for example MIT's Kerberos system. However, these schemes do not scale well to large, inter-organizational populations, and they also carry extra security procedures.

Public-Key Cryptography

Each public-key cryptosystem has its own technical nuances, however they each have the same basic property that given an encryption key it is computationally infeasible to determine the decryption key (and vice-versa). This property lets a person publish their encryption key. Anyone else can use that public key to encrypt a message but only the person can decipher with the private key. That person “owns” the “key-pair.” In practice, computing a public-key cipher takes much longer than encoding the same message with a secret-key system. This has lead to the practice of encrypting messages with a secret-key system such as DES, then encoding the secret key itself with a public-key system such as RSA. That is, the public-key system “transports” the secret key. Since the secret key is usually much shorter than the message, this technique results in significantly faster processing than if public-key cryptography alone were used. Thus each securely transmitted message has two components: the message proper (encoded with a secret-key system) and the key used to encode the message (itself encoded using a public-key system). Reading the message is hence a two-step process: first decode the secret key, and then decode the message. In this document, when we say that a person used a public key to encrypt a message, or that a message is encrypted, we are referring to this combined technique.

Digital Signatures

The very nature of public-key cryptography permits a form of message signing. Suppose a person publishes their decryption key and keeps their encryption key secret. When that person encrypts a message, anyone can decrypt it using the public decrypting key and, in doing so, they can be sure that the message could only have been encrypted by that person, since they are the sole possessor of the encryption key. That person has effectively “signed” the message.

Hash Functions

Typically, to digitally sign a message, rather than encrypt the message using a public-key scheme, the message is hashed using a cryptographic hash function, and the hash is encrypted. A cryptographic hash function maps an arbitrary-length message to a fixed number of bits. Hash functions have the following properties:
They are collision-free: it is computationally infeasible to find two different messages that have the same hash;
They are one-way: given a message hash, it is computationally infeasible to find any message with the same hash value.
The first property in fact implies the second but both are listed to better illustrate the concept. Hash functions are also called message digest or fingerprint algorithms. For example MD5 and SHA-1.

As stated above, digitally signing a message using hashes is a two-step process. The message is first hashed and its hash result is then encrypted using a public-key scheme. Next the message is transmitted along with its encrypted hash. In order to verify the signature, the recipient needs to hash the message, followed by a decryption on the transmitted hash and compare the pair of hash values. The signature is valid if the two values match, otherwise the message was somehow altered, or even maliciously modified in transit.

Public-Key Infrastructure

In its most simple form, a Public-Key Infracture (PKI) is a system for publishing the public-key values used in public-key cryptography. There are two basic operations common to all PKI's:
Certification is the process of binding a public-key value to an individual, organization or other entity, or even to some other piece of information, such as a permission or credential.
Validation is the process of verifying that a certification is still valid.
   Certification

Certification is the fundamental function of all PKIs. It is the means by which public-key values, and information pertaining to those values, are published. For our purposes, we define a certificate as the form in which a PKI communicates public key values or information about public keys, or both.

This is a very broad definition of a certificate. At its most basic, a certificate is merely a public key value. In more traditional terms, a certificate is a collection of information that has been digitally signed by its issuer. Such certificates are distinguished by the kind of information they contain.

A certificate user is an entity who relies upon the information contained in a certificate. The certificate user trusts the issuing authority to issue “true” certificates. That is, certificates which truly identify the subject and its public key (in the case of identity certificates), or which truly describe a subject's credentials (in the case of credential certificates). The certificate issuer is commonly called a certification authority (CA).

To help illustrate these concepts, we present an example using identity certificates. Imagine that Person A wishes to securely communicate with Person B using a public key cryptosystem. Person A needs to know the value of Person B's public encrypting key. Without a PKI, Person A must have direct knowledge of that key, i.e. Person B must communicate it to Person A via a secure channel. If Person A also wishes to communicate with Person C, then Person A must also have direct knowledge of Person C's public encrypting key.

With a PKI, Person A only needs to have direct knowledge of a CA's public signing key. The CA would issue an identity certificate for each of Person B's and Person C's public encrypting keys. Then if Person A wishes to communicate with Person B or Person C, Person A can use the appropriate certificate to obtain the correct public key value. In this case, Person A is the certificate user while Person B and Person C are both the subjects of different certificates.

Validation

The second basic PKI operation is certificate validation. The information in a certificate can change over time. A certificate user needs to be sure that the certificate's data is true, the user needs to validate the certificate. There are two basic methods of certificate validation:
The user can ask the CA directly about a certificate's validity every time it is used.
The CA can include a validity period in the certificate—a pair of dates that define a range during which the information in the certificate can be considered as valid.
A PKI can use either or both methods. How a certificate user validates certificates is a basic PKI characteristic.

Closely related to the validation method is certificate revocation. Certificate revocation is the process of letting users know when the information in a certificate becomes unexpectedly invalid. This can occur when a subject's private key becomes compromised, or, more benignly, when a certificate's identifying information changes for example the subject gets a new telephone number.

If a certificate is validated online with the CA every time it is used then the revocation problem becomes trivial, as the CA can simply state that the certificate is no longer valid. However, when validity periods are employed, the certificate revocation method becomes critical (especially in the case of private-key compromise). How a PKI revokes certificates is a basic PKI characteristic.

In the absence of online approaches, the most common revocation method uses certificate revocation lists (CRLs). A CRL is a list of revoked certificates that is signed and periodically issued by a CA. It is essential that the user check the latest CRL during validation to make sure that a certificate they are about to use has not been revoked.

Online revocation and validation methods are still very new. While it appears that an online approach avoids CRL management problems, the bandwidth and processing requirements of such approaches remain unclear. In lieu of or as a supplement to checking against a periodic CRL, it may be necessary to obtain timely information regarding the revocation status of a certificate. Examples include high-value funds transfer or large stock trades. The Online Certificate Status Protocol (OCSP) enables applications to determine the (revocation) state of an identified certificate. OCSP may be used to satisfy some of the operational requirements of providing more timely revocation information than is possible with CRL's and may also be used to obtain additional status information. An OCSP client issues a status request to an OCSP responder and suspends acceptance of the certificate in question until the responder provides a response.

Time Stamping

A time stamp is a certification by a trusted third party, who is recognized as having a reliable timekeeping device that a particular message existed at a specific time and date. In the traditional paper context, notaries often perform a time-keeping function by indicating the date on which a document was signed. In the digital context, trusted third parties generate a trusted time stamp for a given message by having a time-stamping service append a time value to a message (or to a digest of it) and then digitally signing the result. Such a digital time-stamp maybe used as evidence in support of non-repudiation.

Digital Signature Applications

Digital information and data have numerous advantages over paper-based information, such as the ability to convey data at the speed of light by using wide-area networks (e.g. the Internet), or the ability to search more efficiently. However, numerous problems (technical, legal and organizational) arise during wide-scale employment of digital documents. One of the main problems that hinder people from replacing ordinary documents with digital ones is related to signatures. It is impossible to use ordinary hand-written signature for proving the relationship between the signer and the document to be signed. For paper-based documents both the content of the document (text, pictures etc) and the signature are written on the paper and it is impossible to alter them without leaving telltale signs. For digital information we do not have such a tight relationship between the content of the document and the storage medium. Data can be copied millions of times from one medium (e.g. hard disk, CD etc) to another, or transmitted using networks etc. without affecting the quality of data. There is no way to distinguish between the original and copy of an electronic document. It is easy to change any part of electronic document, for example by using a text editor. One possibility is to use cryptographic methods instead of ordinary signatures. Digital signature is a data-item (formed by the signer) that is created from the document to be signed and the private key of the signer using special software/hardware. Digital signature can be checked and proved valid by using the unique public key that corresponds to the private key of the signer. Digital signature relates a digital document to the signatory in a secure and reliable way. The signature of one document cannot be used as a signature of another document even if the documents in question differ just by a single character.

Digital signatures are intended to meet two different (though, frequently mixed-up) security goals: Authentication means convincing the verifier that (1) the person communicating with him via a public network is who he is claiming he is, and that (2) the things he seems saying are those he really said. Non-repudiation means ability to prove to a third party (e.g. a judge) that a letter or a document received via a public network was written/sent by the claimed originator. However, neither of these goals is achievable by using digital signatures alone: additional technical and organizational measures should be taken. A digital signature on its own doesn't carry much weight as technological evidence. It should be accompanied by a chain of certificates leading to a trusted CA certificate, revocation information (CRL or OCSP response or similar such information) for all the certificates in the chain and a time-stamp over all this information. The assumption being made here is that there is a set of trusted Certificate authority certificates that the system/process trusts explicitly and faithfully.

Any digitally signed information should also be associated with a signature policy depending on the legal laws applicable to that signed document. Since all this information is basically a blob of bytes, there is a need for a trusted third party that can not only obtain and verify the validation information (certs, CRLs, signatures) but which can reliably archive this information for later use (such as for dispute settlements).

Prior Arts Patents

U.S. Pat. No. 5,781,629 titled “Digital Document Authentication System” describes a system and process for time-stamping a digital document that allows for the authentication of a document at a later time but which includes a name or nickname that allows for the unique identification of the document at a later time. This invention focuses on the processing of a collection of digital documents but does not allow the public to retrieve and validate a digitally signed document.

U.S. Pat. No. 5,748,738 and U.S. Pat. No. 5,615,268 both titled “System and Method for Electronic Transmission Storage and Retrieval of Authenticated Documents ” describes a system and a method for authenticating electronic documents. In addition, they focus on the integrity of the outgoing documents and non-repudiation of the outgoing documents, and use an extra second signature of a third party where the trust comes from. However, the second signature will have the same concerns as the original signature.

EP 859488A2 titled “Method and Apparatus for authenticating electronic documents” describes a system and a method for authenticating electronic documents. This patent is similar to US patent (U.S. Pat. No. 5,748,738 mentioned above) where the trusted party appends an “authenticator identification envelope”.

Object of the Invention

It is an object of this invention to provide an improved system for the management of digital documents, stored in a database and in particular provide for the authenticity of the documents.

### SUMMARY OF THE INVENTION

With the above objects in mind the present invention provides in one aspect an apparatus for the management of digital information in a database. This apparatus includes a means for importing the digital information; means for processing the digital information, wherein the digital information may include at least one digital document, at least one digital signature, at least one public key certificate, at least one archival policy; means for obtaining data from an external server and means for exporting output information from the apparatus, whereby a user when importing the digital information to the apparatus, causes the digital information to be processed thereby generating the output information that is stored in the database.

Preferably the archival policy of the apparatus includes an owner identity, payload information, archival period, access mode to server, user access rights, logical file location in repository, cryptographic details, and payment model. Preferably the means for processing the digital information of the apparatus when completed, returns a response to the user.

Preferably the data in the apparatus includes time stamp information.

Preferably the data in the apparatus includes revocation information.

Preferably the data in the apparatus is bound with the digital information in the database.

Preferably the external server in the apparatus belongs to a trusted third party.

Preferably the means of exporting the output information from the database in the apparatus is allowed based on the user access rights defined in the archival policy.

Preferably the means of importing and means of exporting the output information from the database in the apparatus is in a network.

Preferably the network is a client-server configuration or a peer to peer configuration.

Preferably the client-server or peer to peer configuration in the network is web based.

Alternatively the client-server or peer to peer configuration in the network may be electronic mail based.

Alternatively the client-server or peer to peer configuration in the network may be file transfer protocol based.

Alternatively the client-server or peer to peer configuration in the network may be wireless based.

In a further aspect the present invention provides an apparatus for the management of digital information in a database, wherein the apparatus includes a means for importing the digital information; means for processing the digital information, wherein the digital information may include at least one digital document, at least one digital signature, at least one public key certificate, at least one archival policy; and means for exporting output information from the apparatus, whereby a user when importing the digital information to the apparatus, causes the digital information to be processed thereby generating the output information that is stored in the database.

In yet a further aspect the present invention provides a system for managing digital information including;
a receive means for receiving the digital information;
a communication means for obtaining data from at least one external source; and
a processing means for formatting the digital information into an archival document using the data, and storing the archival document in a database.

The digital information may include at least one digital document, at least one digital signature, at least one public key certificate, and at least one archival policy.

In a further aspect the present invention provides a computer program product including a computer usable medium having computer readable program code and computer readable system code embodied on the medium for managing digital information stored on a storage means within a data processing system, the computer program product further including computer readable code within the computer usable medium for:
receiving the digital information;
obtaining data from at least one external source;
formatting the digital information into an archival document using the data, and storing archival document in the storage means.

### BRIEF DESCRIPTION OF THE DRAWINGS

A small number of embodiments of the invention are described hereinafter with reference to the drawings, in which:

FIG. 1 is a block diagram of a digital signed document archival management information apparatus in accordance with the embodiments of the invention;

FIG. 2 illustrates a flowchart of the process within the information processor in accordance with the first embodiment of the invention;

FIG. 3 is a flowchart illustrating the interaction with the trusted third party in accordance with the first embodiment; and

FIG. 4 illustrates a flowchart of the process when a user performs a search on the apparatus.

### DESCRIPTION OF THE PREFERRED EMBODIMENT

The preferred embodiment of the present invention will be discussed hereinafter in detail with reference to the accompanying drawings. Descriptions of specific scenarios are provided only as examples. Consequently, the present invention is not intended to be limited to the embodiments shown, but is to be accorded the widest scope consistent with the principles and features disclosed herein.

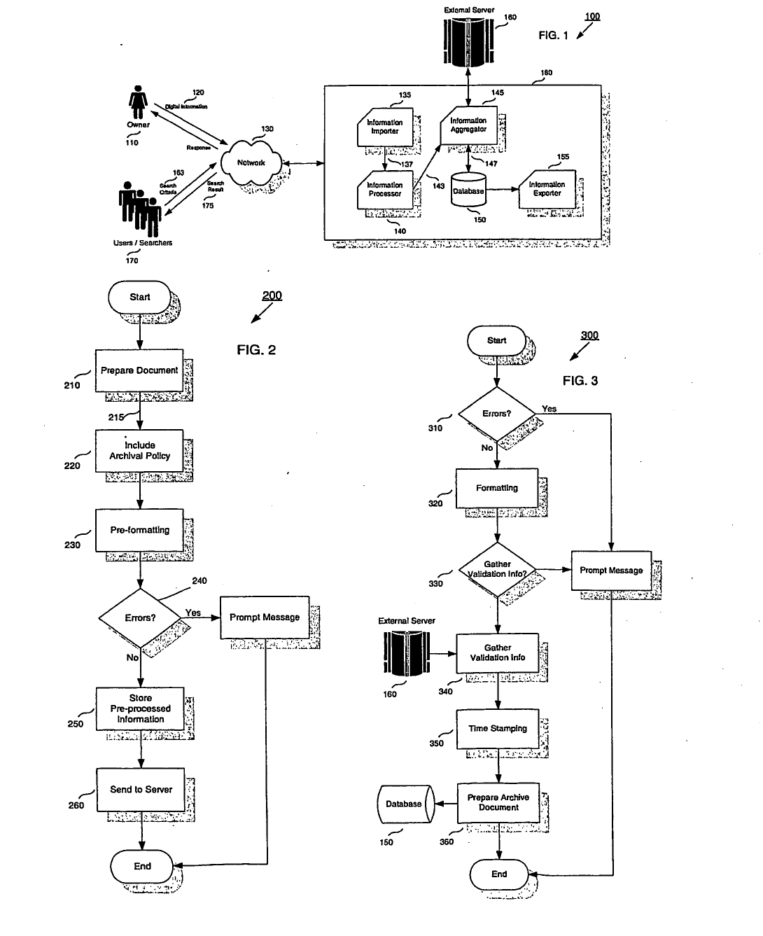

FIG. 1 shows a block diagram of a digital signed document archival management information apparatus or system. An owner (which can be an individual or an automated process) 110 submits a set of digital information 120 which may include at least one digital document, at least one digital signature, at least one public key certificate, and at least one archival policy to the apparatus or system 180 through a network 130. The digital document should also contain the public key certificate associated with any included signature or at the minimum an indication of the signer of the document or a reference to a source where this certificate can be obtained. Any extra certificate that can facilitate the process of certificate path validation is optional. The public key certificate should contain information that can be used to trace the certificate path to a trusted CA certificate or at least an indication on how this process can be achieved. The network 130 then passes on the digital information 120 to the system 180.

The preferred system 180 is constituted by various sub-modules which will be described in detail. The digital information 120 is first passed on to the Information importer 135 which formats the digital information 120 in a form understood by the invention. If the digital information 120 was supplied in an acceptable format or preformatted, then the information importer 135 may simply pass the information on, or even be omitted. The formatted digital information 137 is then passed on to the Information processor 140, which determines the functional requirements, such as obtaining revocation lists, time stamps, etc, that need to be satisfied by the system 180, and any other requirements, for example an archival policy which is required by the implementation of the system.

The functional requirements can be determined based on the archival policy and non-repudiation requirements. For example, the ETSI model explains in detail the set of attributes necessary for non-repudiation. Therefore using such a model the information processor 140 depending on the information provided and the non-repudiation requirements can determine the functional requirements.

This requirement list and formatted digital information 137 is passed on to the Information aggregator 145. The information aggregator 145 depending on the formatted digital information 137 and the requirement list may make external connections to third party servers 160 to obtain the necessary information. This externally obtained information after processing by the information aggregator 145 is transformed into a data structure 147 which is basically the set of information ready for storage. This data structure 147 is then passed on to the database 150 for archival. Optionally the sender 110 can be sent an acknowledgement through the network on the status of the submission.

A user (or any party trying to search the archives of the invention) 170 can submit a search request 163 through the network 130. The search request includes access permission as well as parameters that may enable a successful search operation. The network 130 passes on this request to the system 180 which is then processed by the information exporter 155. The information exporter 155 accesses the archive on the database 150, checks for access control permissions and initiates a search operation. A successful search result 175 is then passed on to the user 170.

FIG. 2 shows the phase where the owner 110 submits the digital information 120 in more detail. The owner 110 prepares 210 the set of digital information to be submitted. Then an archival policy may be added 220 to this information set and this information is pre-formatted in step 230. In some cases the owner 110 might along with the digital signature and the set of certificates, submit validation information such as revocation information. Then the owner 110 will perform necessary pre-formatting to enable the system 180 to include such extra information. The archival policy might be a default one or the user might be given the option of changing/adding new options in the policy. The archival policy may include
1) Identity
   Identification Mechanism (name, email address, phone number, etc)
2) Payload
   With content;
   With only a cryptographic hash of content (cryptographic hashing algorithm should also be included).
   If the content of the document is included, the content might be optionally encrypted.
   If content encrypted encryption algorithm and encryption scheme
3) Archival Period
   Default (according to registration phase choice)
   Archival time period
   Indefinite
4) Access Permission to Server
   Login/Password (with SSL protection)
   SSL with client side authentication
   Anonymous login
   Other access permissions for example modifying archival policy etc.
5) Access Permission to other users
   Registered Users and time periods for same
   Set of passwords for anonymous login and time periods for same
   (These access permissions may also be modified by the appropriate user at a later stage)
6) A file management policy to determine where to store documents in repository
   Default location (Chosen by the system)
   Choose a location
   Temporary location
7) Cryptographic Details
   Time stamping servers (if not default)
   Revocation servers if known (otherwise system searches)
   Time of key sizes/public key, hashing algorithms for time stamping and such
   Archival Type (according to ETSI model or such similar schemes)
8) A Payment Model considering how users of the system pay for the services rendered
9) Mode of Acknowledgement

In practice, many of these options might not have to be selected by the user every time and the default (set during the registration phase) may be used. Preferably, the archival policy can also be modified, or at least some options modified later on by the owner 110.

With regard to the content for the payload there are essentially two modes of content that may be submitted;

i) Content of Digitally Signed Document

This is used to get sufficient evidence to prove at a later time, that an entity did possess a digitally signed document. This document might be signed digitally by the requesting entity or by some other entity. In this case, the proposed invention is aware of the contents of the digital document.

ii) Cryptographic Hash of the Content of the Signed Document

This is used to get sufficient evidence to prove at a later time, that an entity did possess a digitally signed document. This document might be signed digitally by the requesting entity or by some other entity In this case, the proposed invention is unaware of the contents of the digital document but merely obtains a cryptographic hash of the contents of the digital document. Hence the client should also retain a copy of the content (which might be necessary in the future).

After preformatting 230 the information is processed for errors, if any, in step 240. If an error is detected, the owner 110 is informed and the process aborted. Otherwise the information set may be stored locally 250 before being dispatched to the system 180 through the network 130. Alternatively the information may be dispatched immediately.

FIG. 3 describes how the information set submitted to the system 180 is processed. The information importer 135 first checks for any errors in the submitted information in step 310. If an error is detected, the system is advised and the process terminated. On no errors, the information is formatted 320 into a data structure understood by the system. Then depending on the formatted digital information 137 and the archival policy, a decision is made on gathering validation data for the digital signatures carried by the submitted information in step 330. Next the information aggregator 145 in step 340 contacts necessary external servers to gather the necessary aggregation data. Then in step 350, the system, depending on the archival policy, contacts external time stamping servers. Next the information gathered from the external servers such as revocation servers, time stamping servers, access control permissions, archival policy, etc is collated in step 360 and stored in the database 150.

Here we assume that trusted third parties (TTP) provide services such as digital time stamping and revocation information. These services might be based on IETF's PKIX RFC's or any other mechanism. The revocation information can be obtained from CRL's, OCSP responses or any such similar services.

It is assumed that such services will be available for access (with or without authentication, payment etc) for other systems to access.

The present invention provides a mechanism to retrieve this information and bind it with the digital document and the associated signature.

When complete validation information is needed, the system
1) generates a unique random number (nonce) of sufficient number of bits (usually 64 bits or more)
2) For each digital signature and associated public key certificate in the document, obtain all the certificates leading to a trusted CA. If this information is not provided by the requester, the system will try to retrieve this information based on the information provided by the requester. If the information cannot be obtained, an error message is preferably sent to the requester.
3) Validate this certificate chain
4) For each certificate in this certificate chain, obtain revocation information by sending requests to the services providing revocation information.
5) Bind it (using the above generated nonce) in a secure manner with the requests sent to other TTP (Such services usually support a nonce in their request and response). This binding ensures that the requests sent to other external servers belong to one set of requests used to construct the non-repudiable data structure.
6) Once the responses from the other TTP's have been obtained, check that the responses carry the same nonce and bind them in a data structure explained below to the digital signature and document.
7) In case, at a later stage, if the time stamping services' certificate expires or if a cryptographic algorithm used by the digitally signed document becomes weak, the invention automatically (or depending on the archival policy) time stamps the entire data structure using the services of a more secure and validated time stamping service.

The data structure format for storing in the archive may follow the “Electronic Signature Format ” (ETSI model) or a similar scheme.

The digitally validated documents can be stored with a unique identification number in a database. This database can be accessed through a web server or a database connected to the world through electronic mail or any similar mechanisms. This database can either be under immediate control of an individual or an organization managing the documents for a group of individuals. The file structure as visible to the user can be similar to the file systems currently available on operating systems and the archived data files can appear as ordinary files. Their special properties can be accessed/modified/removed (depending on access control rights) using special application specific computer programs. All user interaction can optionally be logged by the system.

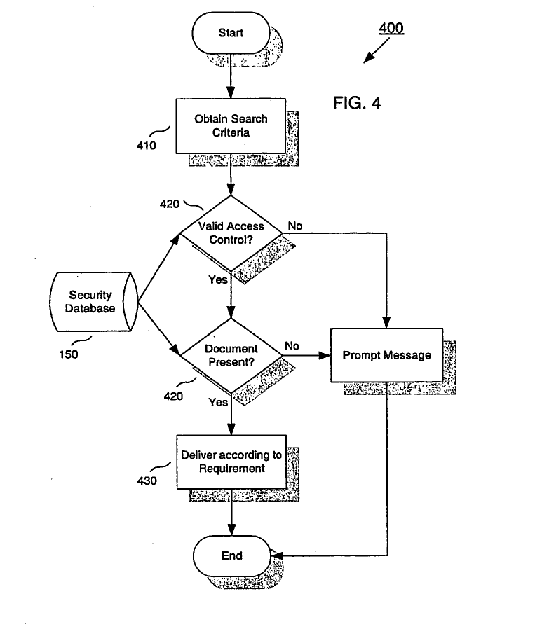

FIG. 4 describes the retrieval operation used to search and retrieve for documents that might be stored in the archive. An entity 170 might submit a search request in step 410. The system then in step 420 checks whether the submitter 170 has proper access control permissions to the requested data. If not, an error is generated and sent back to the submitter 170 and the process terminates. Otherwise, the specific document, if present, (step 420) is retrieved from the database 150 and sent to the search request submitter 170 at step 430.

The electronic database entries can be revealed to the outside world depending on policies associated with each entry that may be determined during the insertion of the record. For example, these policies could be:
The entry can be revealed only to the inserter;
The entry can be revealed to the inserter and a set of other users determined by the inserter;
The entry can be made available on the Internet (wired and wireless) and email; and
The entry can be made available through email only.
The entry can be made available through any means.

Delivery mechanisms can vary depending on the specific needs of the application using this invention. They can follow the traditional login/password mode of authentication, SSL based authentication (optionally with client-side authentication) or use a scheme elaborated below.

When login/password authentication method or client side SSL authentication is used, a suitable search engine can be provided which enables the client to search for archived documents based on 1) time of insertion, modification 2) contents of documents 3) Ownership of document (which can be based on access control permissions) 4) Other document related criteria

The access control mechanism generally used these days is based on login/password mechanisms. This is more so in the case of standard operating systems like Unix and Windows.

A user selects the resources to be shared and selects the list of other users who can have access to this resource. Or simply it is just a common password.

This has the following disadvantages:
1) The other users who want to access resources need to be registered users.
2) Even if just a password is required, this doesn't provide fine-grained access control like who accessed what and when. Especially if we want a certain user revoked and if just a common password is used, this becomes extremely difficult.
   Proposed Preferred Model

1) A user when he selects digital objects for dissemination, selects users who can share this object and what kind of privileges they can enjoy like time period, Read/Write/Modify access etc.

2) Each such user for each such object is assigned a unique password (maybe a long random number).

3) When a user wants to access this resource, the user needs to key in that unique password.

4) It is the responsibility of the owner of the digital resource to control the distribution of these secrets.

5) This can work very well in a web environment with server side authentication for network security.

In some embodiments the system may be implemented within a network, a client server configuration, or peer to peer configuration. The client server configuration may be web based, electronic mail based, file transfer file protocol based, or wireless application protocol based. It will be understood that the type of network is not essential to the working of the invention, and that in some circumstances may not be implemented across a network.

The present invention addresses concerns regarding the authenticity of documents or non-repudiation. Non-repudiation using PKI (digital certificates) not only requires digital signatures by also a set of associated information.

The present invention provides a trusted third party solution where the aggregation of the non-repudiation related information is carried out for the party(ies) involved in a communication, whether on-line or off-line. The solution also archives these transactions so that proof of communication and information exchange can be provided anytime a dispute arises.

1-42. (Cancelled)

43. An apparatus for the management of digital information in a database, comprising:
means for importing said digital information;
means for processing said digital information;
wherein said digital information may include:
at least one digital document,
at least one digital signature,
at least one public key certificate,
at least one archival policy for each document; and
means for exporting output information generated from said digital information from said apparatus, whereby a user when importing said digital information to said apparatus, causes said digital information to be processed thereby generating said output information generated from said digital information that is stored in said database.

44. An apparatus according to claim 43, further including a means for obtaining data from a external server, said data including time stamp information.

45. An apparatus according to claim 44, wherein said data includes revocation information, and bound with said digital information in said database.

46. An apparatus according to claim 44, wherein said external server belongs to a trusted third party.

47. An apparatus according to claim 43, wherein said at least one archival policy further includes at least one of: an owner identity, payload information, archival period, access mode to server, user access rights, logical file location in repository, cryptographic details, and payment model.

48. An apparatus according to claim 43, wherein said means for processing said digital information when completed, returns a response to said user.

49. An apparatus according to claim 47, wherein said means of exporting said output information from said database is allowed based on the said user access rights defined in said archival policy.

50. An apparatus according to claim 43, wherein said means of importing and means of exporting said output information from said database is in a network.

51. An apparatus according to claim 50, wherein said network is a client-server configuration or peer-to-peer.

52. An apparatus according to claim 51, wherein said client-server or peer-to-peer configuration is based on at least one selected from the group consisting of: the web, electronic mail, transfer protocol, and wireless.

53. A system for managing digital information, including:
a receive means for receiving said digital information;
a communication means for obtaining data from at least one external source; and
a processing means for formatting said digital information into an archival document using said data, and storing said archive or document in a database.

54. A system as claimed in claim 53, wherein said digital information includes:
at least one digital document,
at least one digital signature,
at least one public key certificate,
at least one archival policy.

55. A system as claimed in claim 54, wherein said at least one archival policy includes at least one of:
an owner identity,
payload information,
archival period,
access mode to server,
user access rights,
logical file location in repository,
cryptographic details, or
payment model.

56. A system as claimed in claim 54, further including an export means to enable a user to access and/or retrieve said archival document or said digital information.

57. A system as claimed in claim 54, wherein a person inputs said digital information to said receive means, and, following said formatting by said processing means, a response is returned to said person.

58. A system as claimed in claim 54, wherein said data includes certification, validation, time stamp information and/or revocation information, and is bound with said digital information in said database.

59. A system as claimed in claim 54, wherein said at least one external source belongs to a trusted third party, and said communication means determines which digital information requires certification and/or validation, and then communicates with the relevant database and/or server.

60. A system as claimed in claim 56, wherein said export allows access or retrieval by a user based on the said user access rights defined in said archival policy.

61. A system as claimed in claim 56, wherein said receive means and said export means are accessed via a network, said network being a client-server configuration or a peer-to-peer configuration.

62. A system as claimed in claim 61, wherein said client-server or peer-to-peer configuration is selected from the group consisting of: web based, electronic mail based, or file transfer protocol based, and wireless based.

63. A computer program product including a computer usable medium having computer readable program code and computer readable system code embodied on said medium for managing digital information stored on a storage means within a data processing system, said computer program product further including computer readable code within said computer usable medium for:
receiving said digital information;
obtaining data from at least one external source; and
formatting said digital information into an archival document using said data, and storing archival document in said storage means.

64. A computer program product as claimed in claim 63, wherein said digital information includes:
at least one digital document,
at least one digital signature,
at least one public key certificate,
at least one archival policy.

65. A computer program product as claimed in claim 64, wherein said at least one archival policy includes at least one of:
an owner identity,
payload information,
archival period,
access mode to server,
user access rights,
logical file location in repository,
cryptographic details, or
payment model.

66. A computer program product as claimed in claim 64, further including an export means to enable a user to access and/or retrieve said archival document or said digital information.

67. A computer program product as claimed in claim 64, wherein a person inputs said digital information to said receive means, and, following said formatting by said processing means, a response is returned to said person.

68. A computer program product as claimed in claim 64, wherein said data includes time stamp information and/or revocation information, and is bound with said digital information in said database.

69. A computer program product as claimed in claim 64, wherein said at least one external source belongs to a trusted third party, and said communication means determines what digital information requires certification and/or validation, and then communicates with the relevant database and/or server.

70. A computer program product as claimed in claim 66, wherein said export means allows access or retrieval by a user based on the said user access rights defined in said archival policy.

71. A computer program product as claimed in claim 66, wherein said receive means and said export means are accessed via a network, said network being a client-server configuration or a peer-to-peer configuration.

72. A computer program product as claimed in claim 71, wherein said client-server or peer-to-peer configuration is selected from the group consisting of: web based, electronic mail based, file transfer protocol based, and wireless based.
